(19) United States
(12) Patent Application Publication
(10) Pub. No.: US 2025/0389498 A1
(43) Pub. Date: Dec. 25, 2025

(54) INTEGRATED HEAT EXCHANGER

(71) Applicant: Hanon Systems, Daejeon (KR)

(72) Inventors: Ji Hun HAN, Daejeon (KR); Jung Sam GU, Daejeon (KR); Byung Seon CHO, Daejeon (KR)

(73) Assignee: Hanon Systems, Daejeon (KR)

(21) Appl. No.: 19/180,005

(22) Filed: Apr. 15, 2025

(30) Foreign Application Priority Data
May 13, 2024 (KR) 10-2024-0062384

(51) Int. Cl. F28F 9/02; F28D 7/16

(52) U.S. Cl. CPC F28F 9/026; F28D 7/16

(57) ABSTRACT

The present invention relates to an integrated heat exchanger made by integrating two heat exchange parts different in temperatures of cooling fluids, and more particularly, to a technology related to an integrated heat exchanger capable of improving sealing performance of a bridge-type gasket configured to partition two different heat exchange regions.

### CROSS REFERENCE TO RELATED APPLICATION

The present application claims priority to Korean Patent Application No. 10-2024-0062384, filed on May 13, 2024, the entire contents of which are incorporated herein for all purposes by this reference.

### BACKGROUND OF THE INVENTION

### Field of the Invention

The present invention relates to an integrated heat exchanger made by integrating two heat exchange parts different in temperatures of cooling fluids, and more particularly, to a technology related to an integrated heat exchanger capable of improving sealing performance of a bridge-type gasket configured to partition two different heat exchange regions.

### Description of the Related Art

In general, a heat exchanger refers to a device installed in a particular flow path and configured to perform heat exchange by allowing a heat exchange medium, which circulates in the flow path, to absorb heat of outside air or dissipate heat from the heat exchange medium.

The heat exchangers are variously manufactured depending on purpose of use and the use thereof, such as condensers and evaporators that use refrigerants as heat exchange media, radiators and heater cores that use coolants as heat exchange media, and oil coolers that use oil as heat exchange media to cool oil flowing in an engine, a transmission, or the like.

In case that a plurality of heat exchangers for a vehicle is separately manufactured and installed, the number of manufacturing processes increases, which degrades productivity. Further, a significantly large number of materials are wasted, which increases costs and makes it difficult to ensure a space in which the heat exchangers are mounted. Therefore, various technologies for integrating a plurality of heat exchangers have been developed and used to solve the above-mentioned problems.

FIG. 1 is a front schematic view of an integrated heat exchanger in the related art.

As illustrated, the integrated heat exchanger in the related art includes a first core part 10 including a plurality of first tubes 11 in which a first fluid flows, first heat radiating fins 12 interposed between the first tubes 11, and a first header 13 to which two opposite ends of each of the first tubes 11 are coupled, a second core part 20 including a plurality of second tube 21 in which a second fluid flows, second heat radiating fins 22 interposed between the second tubes 21, and a second header 23 to which two opposite ends of each of the and the second tubes 21 are coupled, a single tank 30 simultaneously coupled to the first and second headers 12 and 22 of the first and second core parts 10 and 20 arranged in an upward/downward direction, the single tank 30 being configured to define spaces in which the first and second fluids flow, and one or more baffles 60 installed in the tank 30 and configured to separate the first and second fluids. The integrated heat exchanger in the related art described above is configured such that the baffle 60 partitions the inside of the single tank 30 to simultaneously cool the two types of heat exchange media.

However, in this case, in the integrated heat exchanger, because the two types of heat exchange media with different temperatures circulate in the single tank partitioned by the baffle 60, the tubes and the tank are deformed by a difference in thermal expansion between the tubes 21 and 22 and the tank 60 caused by a temperature difference, which may cause a leak of the heat exchange medium. In order to solve the above-mentioned problem, the pair of baffles 60, which is disposed to be spaced apart from each other, are installed in the tank 30, and a heat blocking slot 31 is formed between the pair of baffles 60 to block heat transfer of the two types of heat exchange media through the tank 30.

Meanwhile, a gasket for sealing the cooling fluid is provided between the first and second headers 13 and 23 and the tank 60, and a bridge-type sealing gasket is also provided between the pair of baffles 60 and the tank 60 in a width direction of the tank 60. The bridge-type gasket is provided in a seating space formed between adjacent tube insertion holes in the tank 60. In consideration of a situation in which the bridge-type gasket expands during an assembling process, a width of a bridge-type gasket in a longitudinal direction of the tank may be smaller than a width of the seating space in the longitudinal direction of the tank.

The above-mentioned bridge-type gasket needs to be seated and compressed at a center of the seating space during the assembling process to easily ensure the sealing performance. In case that the bridge-type gasket is compressed to be biased toward one side, there is a problem in that the sealing performance deteriorates, and there is a high likelihood that the cooling fluid leaks when the bridge-type gasket is used over a long period of time.

### SUMMARY OF THE INVENTION

An object of the present invention is to provide an integrated heat exchanger including a bridge-type gasket having a seating protrusion having a width equal to a width of a seating space so that the bridge-type gasket is seated at a center of the seating space when a tank is seated.

Another object of the present invention is to provide an integrated heat exchanger in which a seating protrusion is formed only in a partial region in consideration of a filling ratio in a seating space when a bridge-type gasket is compressed.

An embodiment of the present invention provides an integrated heat exchanger including: a pair of header tanks in which a space in which a heat exchange medium is stored and flows is formed by coupling a header and a tank, the pair of header tanks being disposed to be spaced apart upward and downward from one another and including a gasket interposed between the header and the tank to seal a coupling portion between the header and the tank; a plurality of refrigerant tubes configured to connect the pair of header tanks; and baffles formed in a width direction of the header tank to partition internal spaces of the header tanks, in which the gasket includes: a peripheral portion to seal a periphery of the header and a periphery of the tank; and a bridge formed in the width direction to seal a coupling portion between the baffle and the header and configured to connect one side and the other side of the peripheral portion in the width direction, and in which a single seating protrusion or a plurality of seating protrusions is formed on the bridge, has a predetermined thickness in the width direction, and extends toward two opposite sides in a longitudinal direction.

In addition, the header may include a plurality of tube insertion holes disposed to be spaced apart from one another in the longitudinal direction so that an end of the tube is inserted, the bridge may be provided in a seating space formed between the adjacent tube insertion holes formed in the width direction of the header, a longitudinal thickness of the bridge may be smaller than a longitudinal thickness of the seating space, and a longitudinal thickness of the seating protrusion may correspond to the longitudinal thickness of the seating space.

In addition, the bridge may include: a straight portion formed at a widthwise center; and inclined portions extending from two opposite sides of the straight portion in the width direction and having a height that decreases outward in the width direction, and the seating protrusion may be formed on the straight portion.

In addition, a filling ratio in the seating space may be 100% or less when the bridge is seated in the seating space and compressed.

In addition, the seating protrusion may include: an upper protrusion formed outward in a height direction of the integrated heat exchanger and extending to have a constant width in the height direction; and an inclined protrusion formed inward in a height direction of the upper protrusion and having a width that decreases inward in the height direction.

In addition, the seating protrusion may further include a seating protrusion hole formed through the seating protrusion in the width direction.

In addition, the seating protrusion hole may be formed through the upper protrusion.

In addition, the baffles may include: a first baffle configured to partition the other side of a first heat exchange medium space formed at one side of the header tank in the longitudinal direction; and a second baffle spaced apart from the other side of the first baffle in the longitudinal direction and configured to partition one side of a second heat exchange medium space formed at the other side of the header tank in the longitudinal direction, and the bridges may include: a first bridge configured to seal a portion between the first baffle and the header; and a second bridge configured to seal a portion between the second baffle and the header.

In addition, the integrated heat exchanger may further include a dummy tube disposed between the refrigerant tubes, having two opposite ends connected to the pair of header tanks, and inserted into the header between the pair of first and second baffles.

In addition, no heat exchange medium may flow in the dummy tube.

Further, the dummy tube may be formed in the same shape as the refrigerant tube.

### BRIEF DESCRIPTION OF THE DRAWINGS

FIG. 1 is a front schematic view of an integrated heat exchanger in the related art.

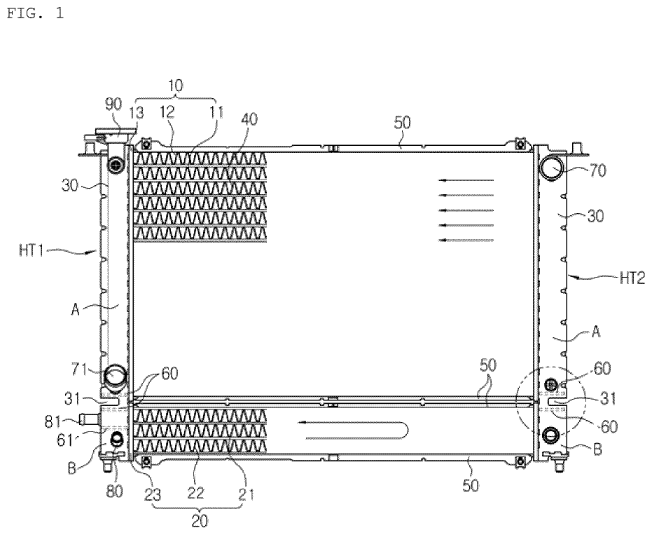

FIG. 2 is a perspective view of an integrated heat exchanger of the present invention.

FIG. 3 is an exploded perspective view of the integrated heat exchanger of the present invention.

FIG. 4 is a longitudinal direction cross-sectional view of the integrated heat exchanger of the present invention.

FIG. 5 is a width direction cross-sectional view of the integrated heat exchanger of the present invention.

FIG. 6 is a partially enlarged perspective view of a gasket of the present invention.

FIG. 7 is a partially enlarged top plan view of the gasket of the present invention.

FIG. 8 is a side view of a bridge of the gasket of the present invention.

FIG. 9 is a cross-sectional perspective view of a bridge of a first embodiment of the present invention.

FIG. 10 is a cross-sectional perspective view of a bridge of a second embodiment of the present invention.

### DETAILED DESCRIPTION OF THE INVENTION

Hereinafter, the present invention will be described in more detail with reference to the drawings. The following embodiments are presented as examples for sufficiently providing the spirit of the present invention to those skilled in the art to which the present invention pertains. The present invention is not limited to the embodiments to be described below and may be specified as other aspects.

Hereinafter, an integrated heat exchanger of the present invention configured as described above will be described in detail with reference to the accompanying drawings.

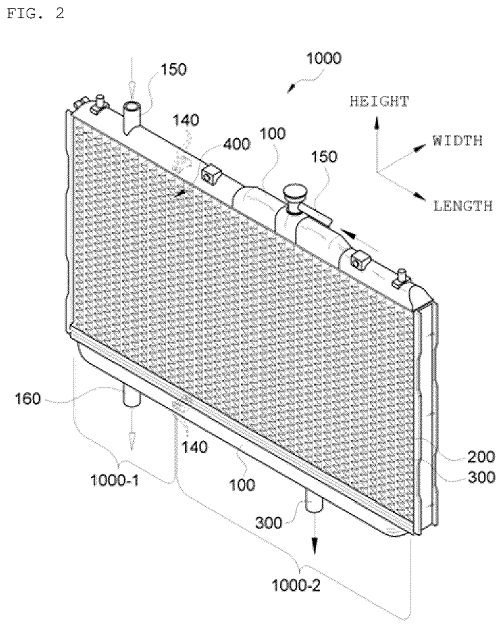

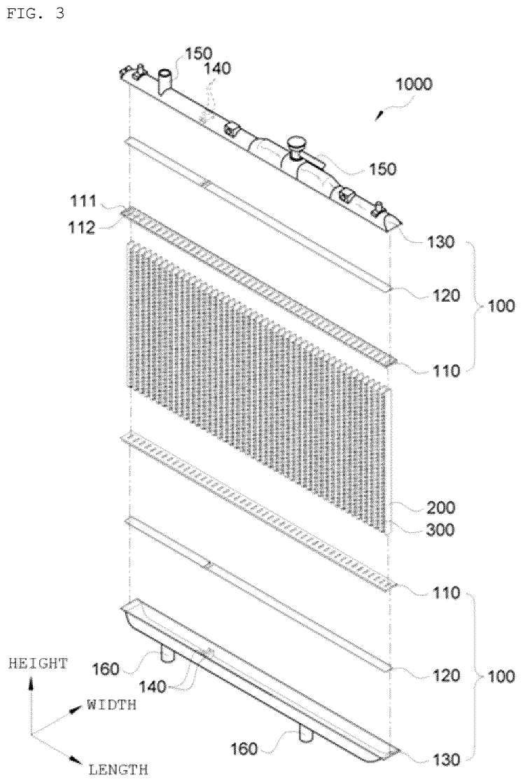

FIGS. 2 and 3 are a perspective view and an exploded perspective view illustrating an integrated heat exchanger according to an embodiment of the present invention.

As illustrated, an integrated heat exchanger 1000 according to an embodiment of the present invention includes a header tank 100 in which a space, in which a heat exchange medium may be stored and flow, is formed by coupling a header 110 and a tank 130, and a gasket 120 is interposed between the header 110 and the tank 130 and seals a portion where the header 110 and the tank 130 are coupled.

More specifically, the integrated heat exchanger 1000 of the present invention may include a pair of header tanks 100 disposed to be spaced apart upward and downward from each other, a plurality of refrigerant tubes 200 configured to connect the pair of header tanks 100, and a plurality of fins 300 interposed between the adjacent tubes 200.

The header tanks 100 may define flow paths in which the heat exchange medium flows. The header tanks 100 may be disposed in parallel and spaced apart from each other at a predetermined distance. Further, the header tank 100 is formed by coupling the header 110 and the tank 130. The gasket 120, which is a sealing member, is provided in the portion where the header 110 and the tank 130 are coupled to each other, thereby preventing a leak of the heat exchange medium. In addition, the header tank 100 may have an inlet pipe 150 through which the heat exchange medium is introduced, and an outlet pipe 160 through which the heat exchange medium is discharged. In addition, an internal space of the header tank 100 may be partitioned by baffles 140 or the like. More specifically, a pair of baffles 140 may be provided in the header tank 100, and an empty space, in which no heat exchange medium flows, may be formed between the pair of baffles 140. Therefore, regions, in which different heat exchange media may flow, are formed to be sealed at one side and the other side based on the empty space, such that the empty space may be formed between the regions in which the heat exchange media with different temperatures flow.

The refrigerant tube 200 defines a heat exchange medium flow path as two opposite ends of the refrigerant tube 200 are inserted into the tube insertion holes 112, which are formed in the header 110 of the header tank 100, and then fixed by brazing or the like. The refrigerant tube 200 is a portion where the heat exchange medium performs heat exchange while passing through the refrigerant tube 200. In this case, the header 110 has a plurality of tube insertion holes 112 into which ends of the refrigerant tubes 200 are inserted. The plurality of tube insertion holes 112 are formed in parallel and spaced apart from one another at predetermined distances in the longitudinal direction of the header 110, such that the plurality of refrigerant tubes 200 may be disposed in parallel and spaced apart from one another in the longitudinal direction.

The fins 300 may be interposed between the refrigerant tubes 200. The fins 300 may be coupled to the refrigerant tubes 200 by brazing or the like in a state in which the fins 300 are disposed to adjoin the refrigerant tubes 200. The fins 300 may be formed in a corrugated shape and serve to improve heat exchange efficiency by increasing a heat radiation area of the heat exchange medium passing through the refrigerant tubes 200.

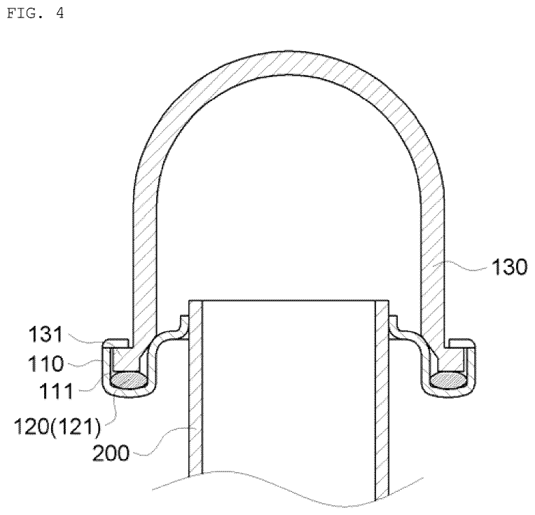

FIG. 4 is a longitudinal direction cross-sectional view of the integrated heat exchanger and illustrates a coupling structure between the gasket 120, the header 110, and the tank 130.

As illustrated, the header tank 100 includes the header 110 having a gasket seating groove 111 formed in a rim portion thereof, the gasket 120 including a peripheral portion 121 inserted into the gasket seating groove 111, and the tank 130 in which a coupling portion 131 having an opened end is tightly attached to the peripheral portion 121 of the gasket 120 and coupled to the header 110 to form a space in which the heat exchange medium flows.

In this case, the gasket seating groove 111 may be formed in a rim portion of the header 110 so that the gasket 120 may be inserted and disposed in the gasket seating groove 111. The gasket seating groove 111 may be concavely formed along the entire periphery of the header 110.

The gasket 120 may have the peripheral portion 121 corresponding in shape to the gasket seating groove 111 formed in the header 110. Therefore, the peripheral portion 121 of the gasket 120 is disposed and inserted into the gasket seating groove 111.

The tank 130 is a portion coupled to the header 110 and configured to define a space in which the heat exchange medium may be stored and flow. The tank 130 may be provided in the form of a concave container opened at one side thereof. The tank 130 may have the coupling portion 131 provided along a periphery of an opened end thereof. The coupling portion 131 may be inserted into the gasket seating groove 111 of the header 110. Therefore, the peripheral portion 121 of the gasket 120 is inserted into the gasket seating groove 111 of the header 110.

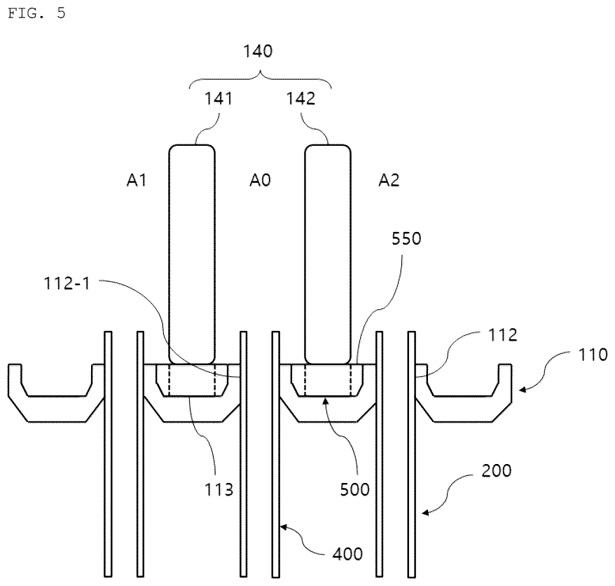

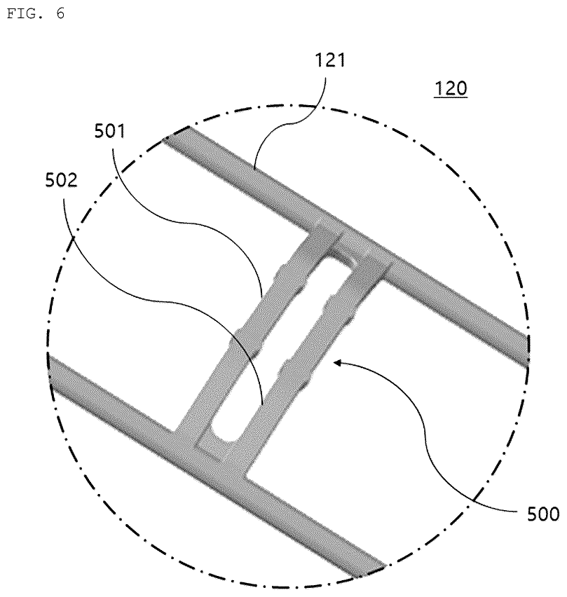

FIG. 5 is a width direction cross-sectional view of the integrated heat exchanger and illustrates a coupling structure between a bridge 500 of the gasket 120, the header 110, and the baffle 140. FIG. 6 is a partially enlarged perspective view of the gasket 120 of the present invention.

Meanwhile, the integrated heat exchanger 1000 of the present invention has the following configuration to allow the heat exchange media with different temperatures through one heat exchanger.

The integrated heat exchanger 1000 includes the pair of baffles 140 provided inside the tank 130, spaced apart from each other in the longitudinal direction, and tightly attached to the pair of bridges 500 of the gasket 120 to partition the internal space formed by coupling the header 110 and the tank 130. The baffles 140 may include a first baffle 141 and a second baffle 142 formed at one side in the longitudinal direction. A first heat exchange region A1 in which a first heat exchange medium flows may be formed at one side of the first baffle 141 in the header tank 100, and a second heat exchange region A2 in which a second heat exchange medium flows may be formed at the other side of the second baffle 142. In addition, a thermal insulation region A0, which is an empty space in which no heat exchange medium flows, may be formed between the other side of the first baffle 141 and one side of the second baffle 142. A periphery of the baffle 140 excluding a lower end thereof may be coupled to the tank 130. In case that the baffle 140 is made of the same material as the tank 130, the baffle 140 may be integrated with the tank 130.

The gasket 120 may include the bridge 500 to seal a portion between a lower end of the baffle 140 and an upper surface of the header 110. The bridges 500 may include a first bridge 501 configured to seal the first baffle 141, and a second bridge 502 configured to seal the second baffle 142. Two opposite ends of the pair of bridges 500 spaced apart from each other in the longitudinal direction may be connected to the peripheral portion 121 of the gasket 120. Therefore, the pair of bridges 500 may be connected to two opposite widthwise sides of the peripheral portion 121 of the gasket 120. The pair of bridges 500 may be disposed to be spaced apart from each other in the longitudinal direction.

In this case, the bridge 500 of the gasket 120 may be seated in a seating space 113 formed between the adjacent tube insertion holes 112 formed in the header 110. Specifically, the bridges 500 are respectively disposed at two opposite sides based on one tube insertion hole 112 and seated in a seating space 115 formed between the tube insertion holes 112. With the above-mentioned coupling structure, the bridges 500 are placed on the upper surface of the header 110.

Meanwhile, the baffle 140 may be formed inside the tank 130 to partition the internal space of the tank 130, and a lower end of the baffle 140 may be formed at a position corresponding to an upper surface of the bridge 500 of the gasket 120. That is, the baffles 140 may be provided as the pair of baffles 140 disposed to be spaced apart from each other in the longitudinal direction. Further, the positions of the pair of baffles 140 formed on the header tank 100 disposed at the upper side and the positions of the pair of baffles 140 formed on the header tank 100 disposed at the lower side may be identical to one another in the longitudinal direction.

Therefore, the coupling portion 131 of the tank 130 may be inserted and coupled into the gasket seating groove 111 of the header 110 in the state in which the gasket 120 is coupled to the header 110. In the state in which the header 110 and the tank 130 are pressed, deformed portions 113, which extend upward from an outer side of the gasket seating groove 111, are bent toward the tank 130, the peripheral portion 121 of the gasket 120 is tightly attached by being pressed by the header 110 and the tank 130, and the bridges 500 of the gasket 120 are tightly attached by being pressed by the header 110 and the baffle 140, such that the header 110, the tank 130, and the gasket 120 may be coupled.

Therefore, the internal space of the header tank 100 may be partitioned by the pair of baffles 140, such that based on the positions at which the pair of baffles 140 are formed, a first heat exchange part 1000-1 may be formed at one side in the longitudinal direction, and a second heat exchange part 1000-2 may be formed at the other side. Further, the first heat exchange part 1000-1 and the second heat exchange part 1000-2 may respectively have inlet pipes and outlet pipes, such that different heat exchange media may flow in the first heat exchange part 1000-1 and the second heat exchange part 1000-2.

In addition, the integrated heat exchanger 1000 may further include a dummy tube 400 disposed between the refrigerant tubes 200 and having two opposite ends connected to the pair of header tanks 100 and connected to the space between the pair of baffles 140. That is, as illustrated, the dummy tube 400 may be disposed in a tube insertion hole 112-1 positioned between the pair of baffles 140 in the longitudinal direction. An upper end of the dummy tube 400 may be connected to the space of the header tank 100 disposed at the upper side, and a lower end of the dummy tube 400 may be connected to the space of the header tank 100 disposed at the lower side. In this case, the dummy tube 400 may be provided in the form of a tube having an empty space therein and opened at two opposite ends thereof and serve to block heat transfer between the two heat exchange parts when the heat exchange media with different temperatures flow in the first heat exchange part 1000-1 and the second heat exchange part 1000-2.

In addition, the inside of the dummy tube 400 may be formed so that no heat exchange medium flows in the dummy tube 400. That is, the two opposite ends of the dummy tube 400 may be connected to the thermal insulation space A0 between the baffles 140, such that the heat exchange medium is not introduced into the dummy tube 400, or the heat exchange medium does not flow along the dummy tube 400.

However, in case that the heat exchange medium leaks from the header tank of the first heat exchange part 1000-1 or the second heat exchange part 1000-2 toward the thermal insulation space A0 and is introduced, the heat exchange medium may be introduced into the dummy tube 400 or flow along the dummy tube 400. Therefore, for example, the dummy tube 400 is formed in a tube shape closed at two opposite ends thereof, such that the heat exchange medium may not flow in the dummy tube 400. In this case, after the dummy tube 400 having the shape opened at two opposite ends thereof is assembled by being inserted into the tube insertion hole 112-1 of the header 110, the two opposite ends of the dummy tube 400 are blocked by being compressed or caulked, such that the heat exchange medium may not be introduced into the dummy tube 400.

In addition, the dummy tube 400 may be formed in the same shape as the refrigerant tube 200. That is, the refrigerant tube 200 may be formed in a tube shape opened at two opposite ends thereof so that the heat exchange medium flows. In case that the dummy tube 400 is formed in the same shape as the refrigerant tube 200, the refrigerant tube 200 and the dummy tube 400 may be commonized, such that the same type of tube may be used for the refrigerant tube 200 and the dummy tube 400 without distinction. In this case, the refrigerant tube 200 may be disposed in the first heat exchange part 1000-1 and the second heat exchange part 1000-2, and the dummy tube 400 may be disposed at the position between the pair of baffles 140 in the longitudinal direction.

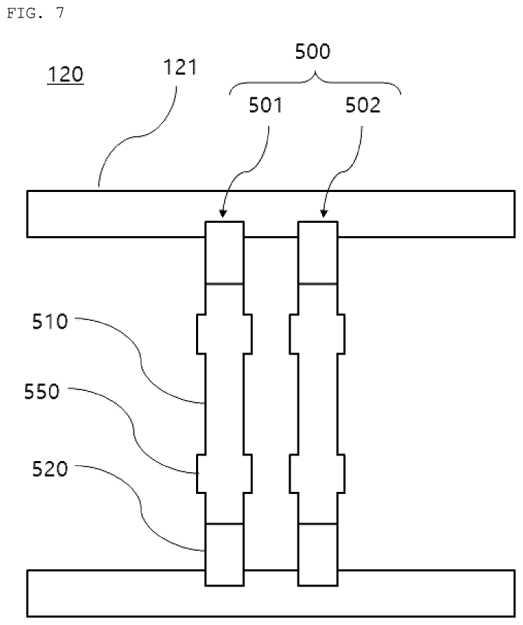

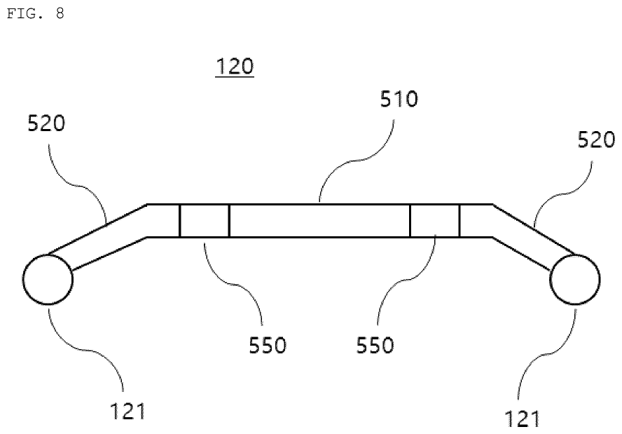

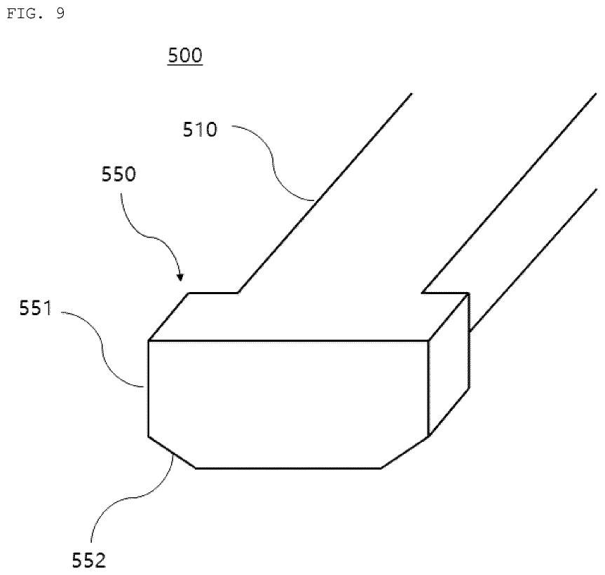

FIG. 7 is a partially enlarged top plan view of the gasket 120 according to the embodiment of the present invention, FIG. 8 is a side view of the bridge 500 of the gasket 120 of the present invention, and FIG. 9 is a cross-sectional perspective view of the bridge 500 of the first embodiment of the present invention.

As illustrated, the gasket 120 includes the peripheral portions 121 configured to seal a tank coupling surface periphery of the header 110 and a header coupling surface periphery of the tank 130, and the bridges 500 configured to seal the seating space 113 of the header 110 and the lower end of the baffle 140. The bridges 500 may include the first bridge 501 provided at the lower end of the first baffle 141 configured to partition the first heat exchange region A1, and the second bridge 502 provided at the lower end of the second baffle 142 configured to partition the second heat exchange region A2.

In addition, the bridge 500 may include a straight portion 510 provided at a widthwise center and corresponding to an upper shape of the seating space 113 of the header 110, and inclined portions 520 formed at two opposite sides of the straight portion 510, extending in the width direction, and inclined downward and outward in the width direction.

In this case, when the bridge 500 is compressed as the header 110 and the tank 130 are coupled, the bridge 500 expands in the longitudinal direction. Therefore, the bridge 500 is formed with a filling ratio of 100% or less in the seating space 113 when the bridge 500 is compressed. This is because a large amount of force is required to compress the bridge in case that the filling ratio exceeds 100%. Therefore, a longitudinal width of the bridge 500 may be smaller than a longitudinal width of the seating space 113. However, in case that the longitudinal width of the bridge 500 is small, it is difficult for the bridge 500 to be seated at the center of the seating space 113 in the longitudinal direction. Therefore, the bridge 500 of the present invention includes the following distinctive configuration.

The bridge 500 may have seating protrusions 550 having the same width as the longitudinal width of the seating space 113 so that the bridge 500 is seated at an exact position when the bridge 500 is seated in the seating space 113. Two opposite ends of the seating protrusion 550 may be formed on the bridge 500 and extend outward in the longitudinal direction, and the seating protrusion 550 may be formed to have a predetermined width. The seating protrusions 550 may be provided as a plurality of seating protrusions 550 spaced apart from one another in the width direction of the bridge 500. In addition, the seating protrusion 550 may be formed on the straight portion 510. When the inclined portion 520 is formed, exact position seating efficiency may deteriorate. In case that the inclined portion 520 formed, a manufacturing process is not easily performed because of an inclination of the inclined portion 520, and it is difficult to maintain the filling ratio of 100% or less because of the seating protrusion 550.

As illustrated in FIG. 9, the seating protrusion 550 may include an upper protrusion 551 formed at an upper side and extending to have a constant width, and an inclined protrusion 552 formed at a lower side of the upper protrusion 551 and having a width that decreases in a downward direction. The inclined protrusion 552 may have a shape corresponding to the seating space 113.

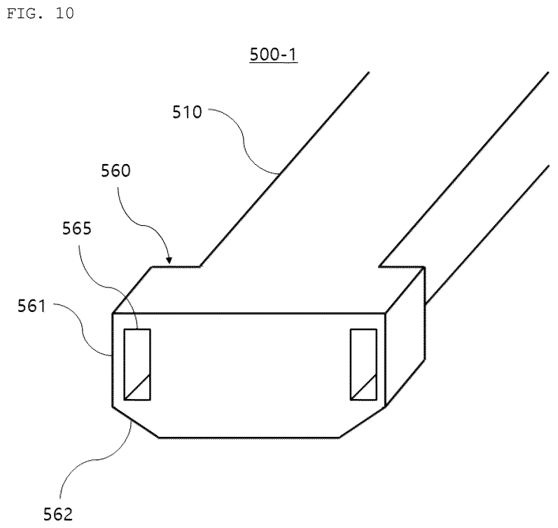

FIG. 10 is a cross-sectional perspective view illustrating a bridge 500-1 of a second embodiment of the present invention. In another embodiment, a seating protrusion 560 has the following configuration for more effectively preventing the situation in which the filling ratio exceeds 100% because of the seating protrusion 560.

As illustrated, the seating protrusion 560 may include an upper protrusion 561 formed at an upper side and extending to have a constant width, and an inclined protrusion 562 formed at a lower side of the upper protrusion 561 and having a width that decreases in a downward direction. Additionally, the seating protrusion 560 may further include seating protrusion holes 565 formed through the upper protrusions 561.

The seating protrusion holes 565 are spaced apart from each other at a predetermined distance and formed inward from a periphery of the upper protrusion 561. The seating protrusion holes 565 may be formed through the upper protrusion 561 in the width direction. The seating protrusion holes 565 may not only allow the bridge 500-1 to be seated at the exact position when the bridge 500-1 is seated in the seating space 113 but also make it easy to adjust the filling ratio of the seating protrusion 560 to 100% or less when the bridge 500-1 is compressed.

According to the integrated heat exchanger of the present invention configured as described above, the bridge-type gasket is guided and seated at the exact position on the tank, the accurate assembling and compression of the bridge-type gasket may be induced, which may ensure excellent performance in sealing the integrated heat exchanger.

In addition, the filling ratio of 100% or less in the seating space may be ensured when the bridge-type gasket is compressed, which may reduce a compressive load required to assemble the tank.

The technical spirit should not be construed as being limited to the embodiments of the present invention. Of course, the scope of application is diverse, and various modifications and implementations may be made by those skilled in the art without departing from the subject matter of the present invention claimed in the claims. Accordingly, these improvements and modifications will fall within the scope of the present invention as long as they are apparent to those skilled in the art.

### DESCRIPTION OF REFERENCE NUMERALS

1000: Integrated heat exchanger
100: Header tank
110: Header
111: Gasket seating groove
112: Tube insertion hole
113: Seating space
120: Gasket
121: Peripheral portion
130: Tank
131: Coupling portion
140: Baffle
141: First baffle
142: Second baffle
150: Inlet pipe
160: Outlet pipe
200: Tube
300: Fin
400: Dummy tube
500: Bridge
501: First bridge
502: Second bridge
510: Straight portion
520: Inclined portion
550: Seating protrusion
551: Upper protrusion
552: Inclined protrusion
565: Seating protrusion hole
A1: First heat exchange region
A2: Second heat exchange region
A0: Thermal insulation region

What is claimed is:

1. An integrated heat exchanger comprising:
a pair of header tanks in which a space in which a heat exchange medium is stored and flows is formed by coupling a header and a tank, the pair of header tanks being disposed to be spaced apart upward and downward from one another and comprising a gasket interposed between the header and the tank to seal a coupling portion between the header and the tank;
a plurality of refrigerant tubes configured to connect the pair of header tanks; and
baffles formed in a width direction of the header tank to partition internal spaces of the header tanks,
wherein the gasket comprises:
a peripheral portion to seal a periphery of the header and a periphery of the tank; and
a bridge formed in the width direction to seal a coupling portion between the baffle and the header and configured to connect one side and the other side of the peripheral portion in the width direction, and
wherein a single seating protrusion or a plurality of seating protrusions is formed on the bridge, has a predetermined thickness in the width direction, and extends toward two opposite sides in a longitudinal direction.

2. The integrated heat exchanger of claim 1, wherein the header comprises a plurality of tube insertion holes disposed to be spaced apart from one another in the longitudinal direction so that an end of the tube is inserted,
wherein the bridge is provided in a seating space formed between the adjacent tube insertion holes formed in the width direction of the header,
wherein a longitudinal thickness of the bridge is smaller than a longitudinal thickness of the seating space, and
wherein a longitudinal thickness of the seating protrusion corresponds to the longitudinal thickness of the seating space.

3. The integrated heat exchanger of claim 2, wherein the bridge comprises:
a straight portion formed at a widthwise center; and
inclined portions extending from two opposite sides of the straight portion in the width direction and having a height that decreases outward in the width direction, and
wherein the seating protrusion is formed on the straight portion.

4. The integrated heat exchanger of claim 2, wherein a filling ratio in the seating space is 100% or less when the bridge is seated in the seating space and compressed.

5. The integrated heat exchanger of claim 2, wherein the seating protrusion comprises:
an upper protrusion formed outward in a height direction of the integrated heat exchanger and extending to have a constant width in the height direction; and
an inclined protrusion formed inward in a height direction of the upper protrusion and having a width that decreases inward in the height direction.

6. The integrated heat exchanger of claim 5, wherein the seating protrusion further comprises a seating protrusion hole formed through the seating protrusion in the width direction.

7. The integrated heat exchanger of claim 6, wherein the seating protrusion hole is formed through the upper protrusion.

8. The integrated heat exchanger of claim 1, wherein the baffles comprise:
a first baffle configured to partition the other side of a first heat exchange medium space formed at one side of the header tank in the longitudinal direction; and
a second baffle spaced apart from the other side of the first baffle in the longitudinal direction and configured to partition one side of a second heat exchange medium space formed at the other side of the header tank in the longitudinal direction, and
wherein the bridges comprise:
a first bridge configured to seal a portion between the first baffle and the header; and
a second bridge configured to seal a portion between the second baffle and the header.

9. The integrated heat exchanger of claim 8, wherein the integrated heat exchanger further comprises a dummy tube disposed between the refrigerant tubes, having two opposite ends connected to the pair of header tanks, and inserted into the header between the pair of first and second baffles.

10. The integrated heat exchanger of claim 9, wherein no heat exchange medium flows in the dummy tube.

11. The integrated heat exchanger of claim 9, wherein the dummy tube is formed in the same shape as the refrigerant tube.
